(19) United States
(12) Patent Application Publication
(10) Pub. No.: US 2009/0303380 A1
(43) Pub. Date: Dec. 10, 2009

(54) Camera Module

(75) Inventor: Tae Jun Seo, Gyunggi-do (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRO-MECHANICS CO., LTD., Suwon (KR)

(21) Appl. No.: 12/285,881

(22) Filed: Oct. 15, 2008

(30) Foreign Application Priority Data
Jun. 10, 2008 (KR) 10-2008-0054292

(51) Int. Cl. H04N 5/225

(52) U.S. Cl. 348/373; 348/E05.024

(57) ABSTRACT

There is provided a camera module. The camera module comprises a lens module including at least one lens; a body coupled to the lens module to allow the lens module to move along an optical axis; a magnet unit applying a predetermined magnetic field to drive the body; and coil film chips each having a predetermined coil integrated in the form of chips and disposed closely adjacent to the magnet unit to generate a driving force by means of a magnetic field provided from the magnet unit, thus to allow the body to move.

### CROSS-REFERENCE TO RELATED APPLICATIONS

This application claims the priority of Korean Patent Application No. 2008-54292 filed on Jun. 10, 2008, in the Korean Intellectual Property Office, the disclosure of which is incorporated herein by reference.

### BACKGROUND OF THE INVENTION

1. Field of the Invention

The present invention relates to a camera module, and more particularly, to a camera module mounted on a camera device such as a small electronic device.

2. Description of the Related Art

In general, a camera module is small in size, and increasingly applied to the field of applications such as portable communication devices such as camera phones, PDAs and smart phones, and various IT apparatuses, etc. Therefore, the camera module itself tends to become smaller in size with the recent development of these small and slim apparatuses.

The camera module is manufactured using an image sensor such as a charge-connected device (CCD) or a complementary metal-oxide semiconductor (CMOS) as a major component, and functions to focus an image of an object through the image sensor, store the focused image as data in a memory of a device and output the stored data as an image through a display medium (such as LCD, a PC monitor or the like) of the device.

In the case of the camera module mounted on small electronic devices such as a mobile communication terminal and the like, a high-specification camera module is also used to implement auto-focusing and zooming functions.

However, the high-specification camera module that can implement auto-focusing and zooming functions has problems in that many complicated components of the camera module make it impossible to manufacture a small camera module, which leads to the mismatch of trends in miniaturization and slimness of mobile communication terminals, etc.

Furthermore, the camera module has problems in that many complicated components of the camera module result in an increase in manufacturing costs or time and an increase in poor products.

### SUMMARY OF THE INVENTION

An aspect of the present invention provides a camera module capable of reducing the manufacturing costs and lowering production of poor products since it may be manufactured on a smaller scale and its components are simple in configuration.

According to an aspect of the present invention, there is provided a camera module, including a lens module including at least one lens; a body coupled to the lens module to allow the lens module to move along an optical axis; a magnet unit applying a predetermined magnetic field to drive the body; and coil film chips each having a predetermined coil integrated in the form of chips and disposed closely adjacent to the magnet unit to generate a driving force by means of a magnetic field provided from the magnet unit, thus to allow the body to move.

In this case, the body, the magnet unit and the coil film chips may be included as one integral assembly in an actuator.

Also, the camera module may further include a housing accommodating the body, the coil film chips may be provided in the body, and included as one integral assembly in the actuator, and the magnet unit may be provided in the housing.

In addition, the camera module may further include a housing accommodating the body, the magnet unit may be provided in the body and included as one integral assembly in the actuator, and the coil film chips may be provided in the housing.

Additionally, a plurality of the coil film chips may be disposed at predetermined distances along the lateral circumference of the body, and the magnet unit may include a plurality of magnets disposed closely adjacent to the respective coil film chips and a bracket anchoring a plurality of the magnets.

Also, the magnet unit and the coil film chip may be disposed to face each other.

In addition, the camera module may further include an accommodating groove provided in the body to accommodate the coil film chips.

Additionally, the camera module may further include accommodating grooves provided inside the housing to accommodate the coil film chips.

Also, a plurality of the coil film chips may be disposed in a lower end of the body, and the magnet unit may include a bracket provided in a lower end of the body and a plurality of magnets anchored to the bracket in regions corresponding to the respective coil film chips.

In addition, the magnet unit may be provided in the anchoring unit formed in a lower inner surface of the housing, and the coil film chips may be provided in a lower end of the body to correspond to the magnet unit.

Additionally, the coil film chips may be provided in the anchoring unit formed in a lower inner surface of the housing, and the magnet unit may be provided in a lower end of the body to correspond to the coil film chips.

Furthermore, the camera module may further include a substrate to which an image sensor is bonded to form an image through the lens module, the coil film chips may be installed in a lateral region of the image sensor of the substrate, and the magnet unit may include a magnetic material with which regions corresponding to the coil film chips provided in the lower end of the body are coated.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is an exploded perspective view illustrating a schematic configuration of a camera module according to one exemplary embodiment of the present invention.

FIG. 2 is a cross-sectional view illustrating an enlarged coil film chip of the camera module according to one exemplary embodiment of the present invention.

FIG. 3 is a diagram illustrating a camera module according to another exemplary embodiment of the present invention, when viewed from the top.

FIG. 4 is a diagram illustrating a camera module according to still another exemplary embodiment of the present invention, when viewed from the top.

FIG. 5 is a diagram illustrating a camera module according to still another exemplary embodiment of the present invention, when viewed from the top.

FIG. 6 is an exploded perspective view schematically illustrating a configuration of an actuator and a housing of a camera module according to still another exemplary embodiment of the present invention.

FIGS. 7 and 8 are diagrams illustrating an operation of the camera module according to still another exemplary embodiment of the present invention.

FIG. 9 is a side cross-sectional view schematically illustrating a camera module according to yet another exemplary embodiment of the present invention.

### DETAILED DESCRIPTION OF THE PREFERRED EMBODIMENT

Hereinafter, exemplary embodiments of the present invention will now be described in detail with reference to the accompanying drawings. However, it should be understood that parts of the drawings may be somewhat exaggerated or different from their real scales for the purpose of illustrations of schematic configurations and their principles of the present invention.

The present invention is basically related to a camera module capable of transferring a lens module by means of a driving force from an electromagnetic field between a magnet and a coil.

In this case, the Fleming's left hand rule is applied to the lens module since the magnet forms a constant magnetic field, and the coil allows an electric current to flow in the magnetic field.

Then, the lens module moves by the driving force of the electromagnetic field. Therefore, the camera module according to one exemplary embodiment of the present invention is characterized in that an actuator may be reduced in size since the coil is basically manufactured in the form of chips.

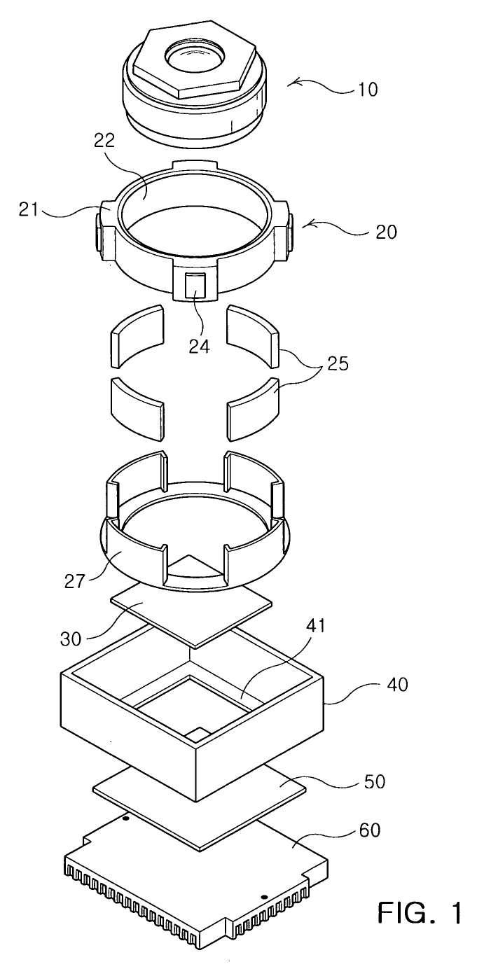

First, the camera module according to one exemplary embodiment of the present invention will be described in more detail referring to FIG. 1. FIG. 1 is an exploded perspective view illustrating a schematic configuration of a camera module according to one exemplary embodiment of the present invention.

As shown in FIG. 1, the camera module according to one exemplary embodiment of the present invention includes a lens module 10 including at least one lens, an actuator 20 allowing the lens module 10 to move along the optical axis to implement auto-focusing and zooming functions.

The lens module 10 is mounted on a mounting hole 22 of the actuator 20, and the actuator 20 having the lens module 10 mounted thereon is mounted on a housing 40.

A substrate 60 is provided in a lower end of the housing 40. Then, an image sensor 50 is bonded to the substrate 60 to be electrically connected to the substrate 60. An IR filter 30 is then provided between the lens module 10 and the image sensor 50.

Also, a hole is provided thorough the housing 40 and actuator 20 to allow the lens module 10 and the image sensor 50 to communicate with each other.

Meanwhile, the camera module according to one exemplary embodiment of the present invention includes a body 21, a coil film chip 24, a magnet unit 25 and bracket 27, which constitute the actuator 20, as shown in FIG. 1.

The magnet unit may be realized in various manners, for example, by anchoring the magnet 25 to the bracket 27, as show in FIG. 1.

Since the body 21 has an accommodating hole 22 formed in the center thereof, the lens module 10 is anchored to the accommodating hole 22.

Also, coil film chips 24 are disposed at predetermined distances along the lateral circumference of the body 21.

Each of the coil film chips 24 is a thin coil chip having a predetermined coil integrated in the form of chips.

Meanwhile, the magnets 25 are anchored to the bracket 27, and the body 21 including the lens module 10 is disposed in the center of the bracket 27, as shown in FIG. 1. In this case, the body 21 and the magnet 25s are spaced at predetermined distances from each other.

Therefore, the magnets 25 form a predetermined magnetic field. In this case, when a power source is applied to the coil film chips 24, a driving force is generated in the magnetic field according to the Fleming's left hand rule. Then, the body 21 may move with the lens module 10 along the optical axis since the body 21 has a space through which the lens module 10 can move in a direction of the optical axis.

When a power source is reversely applied to the coil film chips 24, a driving force is reversely given to the body 21 by the coil film chips 24, and therefore the body 21 move in a reverse direction along the optical axis.

Because the lens module 10 moves on the basis of the above-mentioned operation, the camera module according to one exemplary embodiment of the present invention may implement auto-focusing and zooming functions.

Here, a reference numeral 41 (not shown) represents an anchoring surface that forms the bottom of the housing 40. Therefore, the anchoring surface 41 is an optional component, but not an essential one.

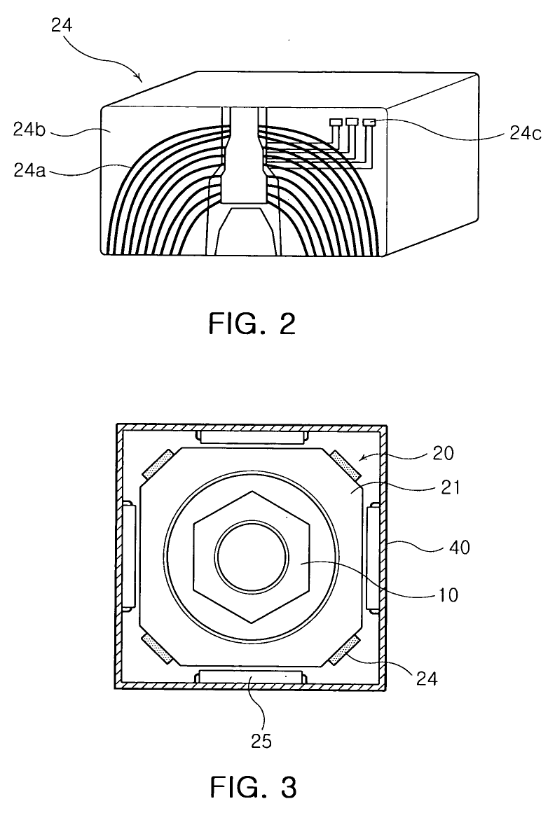

Meanwhile, the coil film chips mounted on the camera module according to one exemplary embodiment of the present invention will be described in detail referring to FIG. 2.

FIG. 2 is a cross-sectional view illustrating an enlarged coil film chip of the camera module according to one exemplary embodiment of the present invention.

As shown in FIG. 2, the coil film chip 24 is one integrated coil apparatus. That is, the coil film chip 24 is manufactured in the form of chips by winding coil around a bobbin.

Such a coil film chip 24 may be manufactured according to methods such as photolithography, etc., which is similar to the method for manufacturing a semiconductor, etc.

As shown in FIG. 2, the coil film chip 24 includes a coil unit 24a, an insulator unit 24b, and a connector unit 24c connected to the coil unit 24a to be electrically connected to external electrodes.

The connector unit 24c is connected to the substrate, as shown in FIG. 1. In this case, the connector unit 24c may be electrically connected to the substrate by means of FPCB, various cables, etc., or be directly installed in the substrate. These connections will be described later in detail.

Meanwhile, the camera module according to another exemplary embodiment of the present invention will be described in detail referring to FIG. 3. FIG. 3 is a diagram illustrating a camera module according to another exemplary embodiment of the present invention, when viewed from the top.

In the case of the camera module according to one exemplary embodiment of the present invention as shown in FIG. 1, the actuator 20 includes both the coil film chips 24 and the magnets 25. In the case of the camera module according to another exemplary embodiment of the present invention as shown in FIG. 3, however, the magnet 25 is anchored to an inner surface of the housing 40.

As shown in FIG. 3, the coil film chips 24 are installed in corners of the body 21 of the actuator 20, respectively, and the magnets 25 anchored to the inner surface of the housing 40 are provided between the coil film chips 24.

The coil film chips 24 and the magnets 25 are spaced at predetermined distances from each other, that is, disposed closed adjacent to each other.

Therefore, a driving force is generated by electric fields generated between the magnets 25 and an electric current flowing in the coil film chips 24. In this case, the driving force allows the body 21, which has a space through which the lens module 10 can move in a direction of the optical axis, to move along the optical axis.

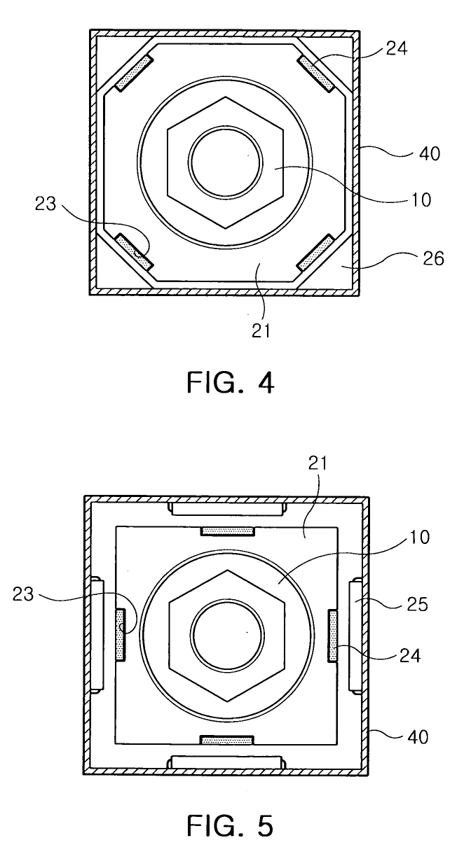

Meanwhile, the camera module according to still another exemplary embodiment of the present invention will be described in detail referring to FIG. 4.

As shown in FIG. 4, a basic configuration of the camera module according to still another exemplary embodiment of the present invention is identical to the camera module as shown in FIG. 3, but both the camera modules are different from each other in aspect of the configurations of magnets and coil film chips.

The coil film chips 24 may be configured so that they can be accommodated in accommodating grooves 23 provided in the body 21 can accommodate the coil film chips 24, as shown in FIG. 4. When the coil film chips 24 are accommodated in the accommodating grooves 23 as described above, it is more advantageous to miniaturize the camera module, and it is possible to protect the coil film chips 24.

Also, the coil film chips 24 and the magnets 25 may be disposed closely adjacent to each other in order to face each other, as shown in FIG. 4.

When the magnets 25 are anchored to corners of the housing 40 as shown in FIG. 4, the camera module according to one exemplary embodiment of the present invention has a characteristic in using a void space. Therefore, the camera module according to one exemplary embodiment of the present invention is more preferably effective for the use of the space when the coil film chips 24 are accommodated in the accommodating grooves 23, and the magnets 25 are simultaneously anchored to the accommodating grooves 23.

Meanwhile, FIG. 5 shows a combination of the configuration of the magnets as shown in FIG. 3 and the configuration of the coil film chips as shown in FIG. 4.

That is, it is possible to anchor the magnets 25 to an inner surface of the housing 40 and accommodate the coil film chips 24 in the accommodating grooves 23 that are provided in regions of the body 21 corresponding to the magnets 25.

In the respective exemplary embodiments as shown in FIGS. 3 to 5, the coil film chips 24 are installed in the body 21, and the magnets 25 are installed in the housing 40, but the present invention is not particularly limited thereto. Also, the coil film chips 24 and the magnets 25 may be installed in a reverse manner.

That is, the magnets 25 may be installed in the body 21, and the coil film chips 24 may be installed in the housing 40.

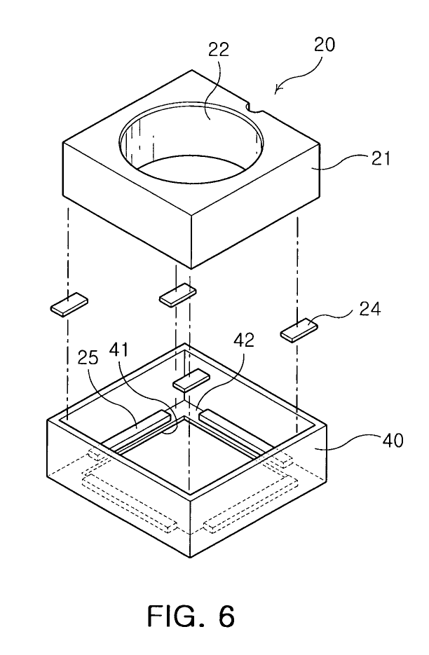

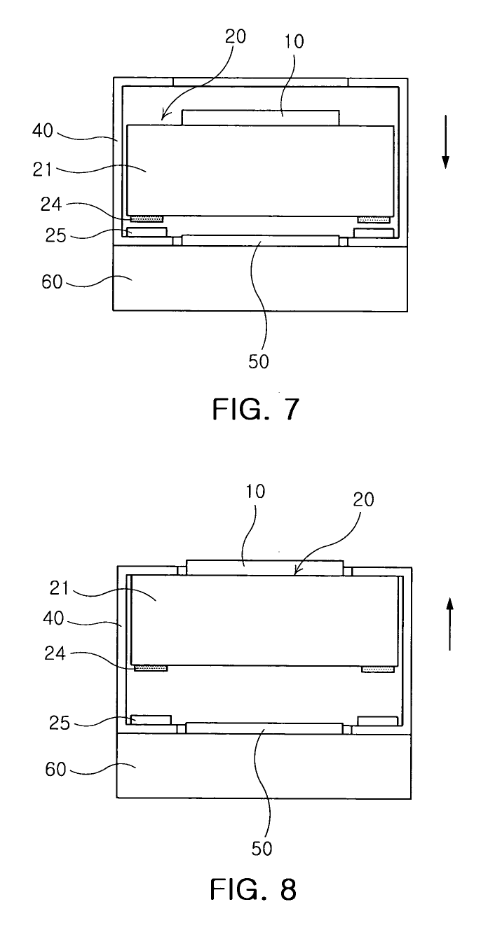

The camera module according to still another exemplary embodiment of the present invention will be described in detail referring to FIGS. 6 to 8. FIG. 6 is an exploded perspective view schematically illustrating a connection configuration of an actuator and a housing of a camera module according to still another exemplary embodiment of the present invention, and FIGS. 7 and 8 are diagrams illustrating an operation of the camera module as shown in FIG. 6.

As shown in FIGS. 6 to 8, the coil film chips 24 may be provided in a lower end of the body 21 in the actuator 20 of the camera module according to still another exemplary embodiment of the present invention, and the magnets 25 may be provided in a lower end, that is, an anchoring surface 41, of the housing 40 that corresponds to the coil film chips 24.

That is, the coil film chips 24 and the magnets 25 are disposed between the lower end of the body 21 of the actuator 20 and a lower inner surface of the housing 40 so that they can be adjacent to each other.

A driving force may be generated in coil film chips 24 by means of electric fields formed in the magnets 25, and the body 21 may move along the optical axis using the driving force.

Although not shown in FIGS. 6 to 8, it is possible to accommodate the coil film chips 24 in the accommodating grooves that are provided in a lower end of the body 21.

As shown in FIGS. 6 to 8, however, it is preferred to ensure a sufficient space of the image sensor 50 and dispose the coil film chips and the magnets using the remainder of the space.

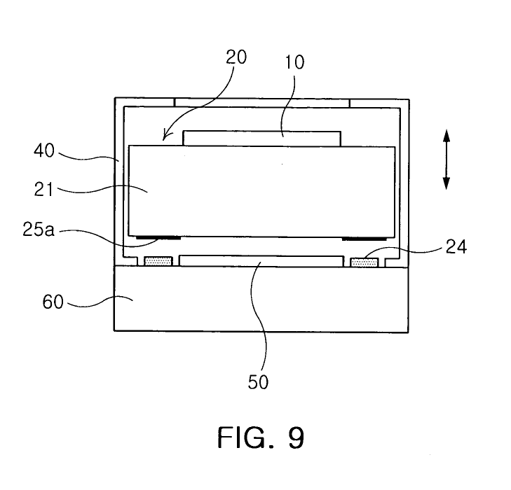

Meanwhile, the camera module according to yet another exemplary embodiment of the present invention will be described in detail referring to FIG. 9.

As shown in FIG. 9, the camera module according to yet another exemplary embodiment of the present invention includes coil film chips 24 installed in a region of the substrate 60 except for the region of the substrate 60 to which the image sensor 50 is bonded.

That is, predetermined grooves may be formed in the substrate 60, and the coil film chips 24 may be installed in the grooves, or bonded to the grooves.

Also, the lower end of the body 21 corresponding to the coil film chips is preferably coated with a magnetic material 25a in order to exchange an electromagnetic force with the coil film chips 24.

As described above, the camera module according to the exemplary embodiment of the present invention may be very easily installed since each of the coil film chips has a coil manufactured in the form of very thin film chips in the camera module.

Therefore, the camera module according to the exemplary embodiment of the present invention may be reduced in size since the coil film chips themselves are manufactured on a smaller scale, and the camera module according to the exemplary embodiment of the present invention may be reduced further in size by suitably disposing the coil film chips together with the magnets since the coil film chips may be easily installed in the camera module.

The camera module according to one exemplary embodiment of the present invention may be useful to reduce the manufacturing costs and lower the production of poor products since it may be manufactured on a smaller scale and its components are simple in configuration.

While the present invention has been shown and described in connection with the exemplary embodiments, it will be apparent to those skilled in the art that modifications and variations can be made without departing from the spirit and scope of the invention as defined by the appended claims.

What is claimed is:

1. A camera module, comprising:
a lens module including at least one lens;
a body coupled to the lens module to allow the lens module to move along an optical axis;
a magnet unit applying a predetermined magnetic field to drive the body; and
coil film chips each having a predetermined coil integrated in the form of chips and disposed closely adjacent to the magnet unit to generate a driving force by means of a magnetic field provided from the magnet unit, thus to allow the body to move.

2. The camera module of claim 1, wherein the body, the magnet unit and the coil film chips are included as one integral assembly in an actuator.

3. The camera module of claim 1, further comprising a housing accommodating the body, and
wherein the coil film chips are provided in the body, and included as one integral assembly in the actuator, and
the magnet unit is provided in the housing.

4. The camera module of claim 1, further comprising a housing accommodating the body, and
wherein the magnet unit is provided in the body and included as one integral assembly in the actuator, and
the coil film chips are provided in the housing.

5. The camera module of claim 2, wherein a plurality of the coil film chips are disposed at predetermined distances along the lateral circumference of the body, and
the magnet unit includes a plurality of magnets disposed closely adjacent to the respective coil film chips, and a bracket anchoring a plurality-of the magnets.

6. The camera module of claim 2, wherein the magnet unit and the coil film chip are disposed to face each other.

7. The camera module of claim 1, further comprising an accommodating groove provided in the body to accommodate the coil film chips.

8. The camera module of claim 4, further comprising accommodating grooves provided inside the housing to accommodate the coil film chips.

9. The camera module of claim 2, wherein a plurality of the coil film chips are disposed in a lower end of the body, and
the magnet unit includes a bracket provided in a lower end of the body and a plurality of magnets anchored to the bracket in regions corresponding to the respective coil film chips.

10. The camera module of claim 3, wherein the magnet unit is provided in the anchoring unit formed in a lower inner surface of the housing, and
wherein the coil film chips are provided in a lower end of the body to correspond to the magnet unit.

11. The camera module of claim 4, wherein the coil film chips are provided in the anchoring unit formed in a lower inner surface of the housing, and
the magnet unit is provided in a lower end of the body to correspond to the coil film chips.

12. The camera module of claim 1, further comprising a substrate to which an image sensor is bonded to form an image through the lens module, and
wherein the coil film chips are installed in a lateral region of the image sensor of the substrate, and
the magnet unit includes a magnetic material with which regions corresponding to the coil film chips provided in the lower end of the body are coated.
